(19) United States
(12) Patent Application Publication
(10) Pub. No.: US 2023/0298313 A1
(43) Pub. Date: Sep. 21, 2023

(54) ANALYSIS APPARATUS, METHOD, AND NON-TRANSITORY COMPUTER-READABLE STORAGE MEDIUM

(71) Applicant: KABUSHIKI KAISHA TOSHIBA, Tokyo (JP)

(72) Inventors: Tsukasa IKE, Tokyo (JP); Yasunobu YAMAUCHI, Yokohama (JP); Ryusuke HIRAI, Tokyo (JP); Izumi FUKUNAGA, Tokyo (JP)

(73) Assignee: KABUSHIKI KAISHA TOSHIBA, Tokyo (JP)

(21) Appl. No.: 17/930,781

(22) Filed: Sep. 9, 2022

(30) Foreign Application Priority Data
Mar. 17, 2022 (JP) 2022-042838

(51) Int. Cl. G06V 10/762; G06V 10/62; G06V 10/74; G06V 10/80

(52) U.S. Cl. CPC G06V 10/762; G06V 10/62; G06V 10/761; G06V 10/803

(57) ABSTRACT

According to one embodiment, an analysis apparatus includes processing circuitry. The processing circuitry acquires sensor data from a measurement target, calculates a state value based on the sensor data, sets, based on time-series data of the state value and predetermined criteria, a plurality of noticed sections in the time-series data, performs clustering using the state value regarding each of the noticed sections and generates a clustering result, and generates, based on the clustering result, stress information including characteristic information of each of a plurality of clusters.

### CROSS-REFERENCE TO RELATED APPLICATIONS

This application is based upon and claims the benefit of priority from Japanese Patent Application No. 2022-042838, filed Mar. 17, 2022, the entire contents of which are incorporated herein by reference.

### FIELD

Embodiments described herein relate generally to an analysis apparatus, a method, and a non-transitory computer-readable storage medium.

### BACKGROUND

Along with the prevalence of wearable devices, each of which is typified by an activity meter, a smartwatch, and the like and has mounted therein sensors for measuring acceleration, temperature and humidity, biosignals, and the like, the development of the technology which recognizes behavior, a state, and the like of a person by utilizing this wearable device has been active. In recent years, endeavors to attempt utilization in industrial fields such as utilization in analysis to improve productivity by classifying work contents on a work-site and utilization in ensuring of safety of workers by conducting fall detection, heatstroke risk estimation, and the like have also been becoming active.

As one of such endeavors, the development of the technology in which by utilizing sensor data measured by the wearable device and images shot by a camera, a load exerted on a worker is measured has also been becoming active. Because work to which an excessive load is applied causes an occupational accident such as an injury of a worker, a reduction in productivity due to stress, and the like, the analysis of the load in work has been undertaken on work-sites since long ago.

For example, there may be a case where the analysis of the workload is conducted by depending on analysis on a field site conducted by an expert having a qualification. However, there are many problems in the analysis conducted by a person such as problems in that not only the analysis takes a long time in that but also it is difficult to analyze a load of psychological stress or the like, which is hardly judged from appearance. Therefore, advantages, for example, in that costs required for the analysis can be reduced and in that utilization for the analysis of the load which is hardly judged from appearance can be made by automatization of workload analysis utilizing sensor data, images, and the like have been expected.

In order to effectively facilitate the reduction in a load exerted on work, it is indispensable to extract work, in which a load is high in particular, from among a series of work sequences and to identify causes thereof. On the other hand, because loads exerted on workers vary depending on various factors such as individual differences such as differences in physiques of the workers, physical strengths thereof, and the like, shapes of work targets, work environment such as temperature and humidity, and work time zones, in order to adequately analyze the causes of the loads, it is considered that analyzing differences in ways of exerting the loads on the workers, caused by these factors, is indispensable.

As an evaluation method of the loads required for the work, there has been known the technology in which a pose is estimated based on a model representing a human body from images obtained by shooting a worker, a kind of work is identified from a change pattern of the pose, a pose of each of work kinds for which a load is required is determined, and load values exerted on sites of a human body are calculated from a duration of the pose, thereby aggregating work kinds and load values of each of the sites.

However, although this technology can identify work in which a load is high and can identify a site or sites on which a load or loads are exerted in the above-mentioned work by aggregating the work kinds and the load exerted on each of the sites of the human body, this technology cannot provide any information to analyze differences in ways of causing the loads due to the factors such as the above-described individual differences and the work environment. Therefore, a technology which can adequately analyze causes of loads from among many considered factors such as the individual differences of workers and the work environment is demanded.

### BRIEF DESCRIPTION OF THE DRAWINGS

FIG. 1 is a block diagram illustrating a configuration of an analysis system which includes an analysis apparatus according to a first embodiment.

FIG. 2 is a block diagram illustrating a configuration of the analysis apparatus according to the first embodiment.

FIG. 3 is a flowchart illustrating operation of the analysis apparatus according to the first embodiment.

FIG. 4 is a graph showing load values of an upper arm, a wrist, and a waist of a worker in the first embodiment in a time-series manner.

FIG. 5 is a diagram explaining another example of setting criteria of noticed sections in the first embodiment.

FIG. 6 is a diagram explaining the noticed section set in another example in FIG. 5.

FIG. 7 is a flowchart illustrating clustering processing in the flowchart in FIG. 3.

FIG. 8 is a diagram explaining combining processing in the first embodiment.

FIG. 9 is a diagram explaining degree-of-similarity calculation processing in the first embodiment.

FIG. 10 is a diagram explaining a clustering result of a plurality of characteristic samples corresponding to a plurality of noticed sections plotted on two-dimensional coordinates in the first embodiment.

FIG. 11 is a diagram explaining an average characteristic sample in each of clusters in FIG. 10.

FIG. 12 is a diagram illustrating display data based on stress information in the first embodiment.

FIG. 13 is a diagram illustrating other display data based on the stress information in the first embodiment.

FIG. 14 is a diagram illustrating display data regarding a first cluster in the first embodiment.

FIG. 15 is a diagram illustrating other display data regarding the first cluster in the first embodiment.

FIG. 16 is a diagram illustrating display data regarding a second cluster in the first embodiment.

FIG. 17 is a diagram illustrating other display data regarding the second cluster in the first embodiment.

FIG. 18 is a diagram explaining a setting criterion of a candidate noticed section in a modification of the first embodiment.

FIG. 19 is a block diagram illustrating a configuration of an analysis apparatus according to a second embodiment.

FIG. 20 is a flowchart illustrating operation of the analysis apparatus according to the second embodiment.

FIG. 21 is a flowchart illustrating clustering processing in the flowchart in FIG. 20.

FIG. 22 is a block diagram illustrating a hardware configuration of a computer according to one embodiment.

### DETAILED DESCRIPTION

In general, according to one embodiment, an analysis apparatus includes processing circuitry. The processing circuitry acquires sensor data from a measurement target, calculates a state value based on the sensor data, sets, based on time-series data of the state value and predetermined criteria, a plurality of noticed sections in the time-series data, performs clustering using the state value regarding each of the noticed sections and generates a clustering result, and generates, based on the clustering result, stress information including characteristic information of each of a plurality of clusters.

Hereinafter, with reference to the accompanying drawings, embodiments of an analysis apparatus will be described in detail.

### FIRST EMBODIMENT

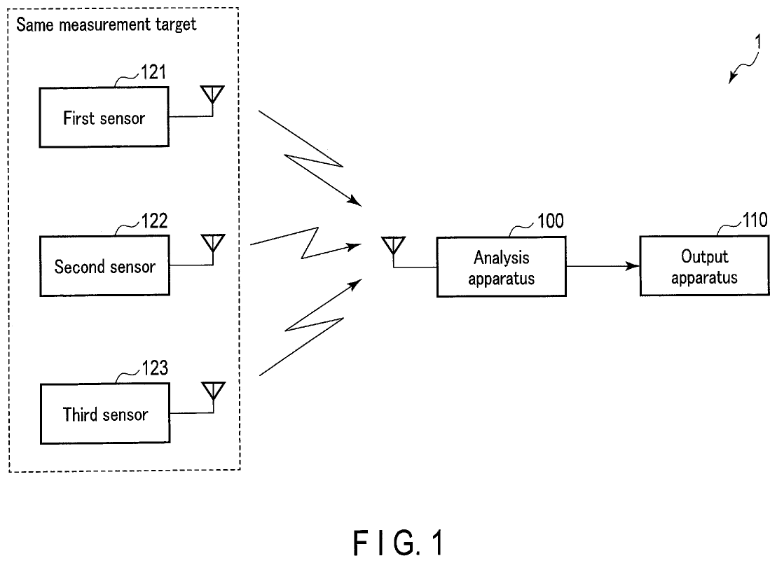

FIG. 1 is a block diagram illustrating a configuration of an analysis system which includes an analysis apparatus according to a first embodiment. The analysis system 1 in FIG. 1 includes the analysis apparatus 100, an output apparatus 110, and one or more sensors. In FIG. 1, as one or more sensors, a first sensor 121, a second sensor 122, and a third sensor 123 are illustrated. Each of these three sensors acquires sensor data as to the same measurement target. The measurement target is, for example, a worker who works on a work-site such as a factory. The analysis apparatus 100 analyzes information (stress information) showing characteristics of stress regarding work based on one or more pieces of sensor data. The output apparatus 110 displays display data based on the stress information.

It is to be noted that the analysis system 1 may include a sensor or sensors which acquire sensor data as to other measurement target. In other words, the analysis apparatus 100 may acquire one or more pieces of sensor data from a plurality of measurement targets.

Furthermore, the analysis system 1 may include an imaging apparatus. The imaging apparatus is, for example, a video camera (camera). The imaging apparatus shoots a work site (for example, an assembly workshop in a factory) on which work is performed by, for example, a measurement target and acquires a still image or a moving image. In the present embodiment, the still image or the moving image acquired by the imaging apparatus is referred to as a work image. In addition, this work image may be used as sensor data.

In addition, a plurality of imaging apparatuses may be included, and the analysis system 1 may concurrently shoot the measurement target by cameras installed in a plurality of positions in case the measured person is hidden by a work object or the like in a position of a specific camera and may acquire a plurality of work images. Furthermore, the imaging apparatus may be an infrared camera which is operable to clearly shoot a silhouette of the measurement target also in work in a dark place.

The output apparatus 110 is, for example, a monitor. The output apparatus 110 receives display data from the analysis apparatus 100. The output apparatus 110 displays the display data. It is to be noted that as long as the output apparatus 110 is operable to display the display data, the output apparatus 110 is not limited to the monitor. For example, the output apparatus 110 may be a projector and a printer. In addition, the output apparatus 110 may include a loudspeaker.

The one or more sensors are built in, for example, a wearable device attached to each of a plurality of body sites of the measurement target. Hereinafter, the wearable device and the sensors are used in the similar meaning. The plurality of body sites is, for example, a wrist, an upper arm, an ankle, an upper leg, a waist, a back, a head, and the like. The sensors of one or more sensors acquire, as sensor data, at least one measurement data, for example, among acceleration data, angular velocity data, geomagnetic data, atmospheric pressure data, temperature and humidity data, muscle potential data, pulse wave data, and the like. The measurement data may include a plurality of channels. For example, in a case where the measurement data is the acceleration data, the sensor data includes pieces of data of three channels corresponding to directions of the acceleration (for example, an X-axis direction, a Y-axis direction, and a Z-axis direction) components. In the present embodiment, a case where as the one or more sensors, the first sensor 121, the second sensor 122, and the third sensor 123 are used will be described.

The first sensor 121 is attached to, for example, the upper arm of the measurement target. The first sensor 121 measures a state of the upper arm of the measurement target as sensor data. The first sensor 121 outputs the measured sensor data to the analysis apparatus 100.

The second sensor 122 is attached to, for example, the wrist of the measurement target. The second sensor 122 measures a state of the wrist of the measurement target as sensor data. The second sensor 122 outputs the measured sensor data to the analysis apparatus 100.

The third sensor 123 is attached to, for example, the waist of the measurement target. The third sensor 123 measures a state of the waist of the measurement target as sensor data. The third sensor 123 outputs the measured sensor data to the analysis apparatus 100.

In a subsequent specific example, it is described that the analysis apparatus 100 uses pieces of the sensor data acquired from the first sensor 121, the second sensor 122, and the third sensor 123.

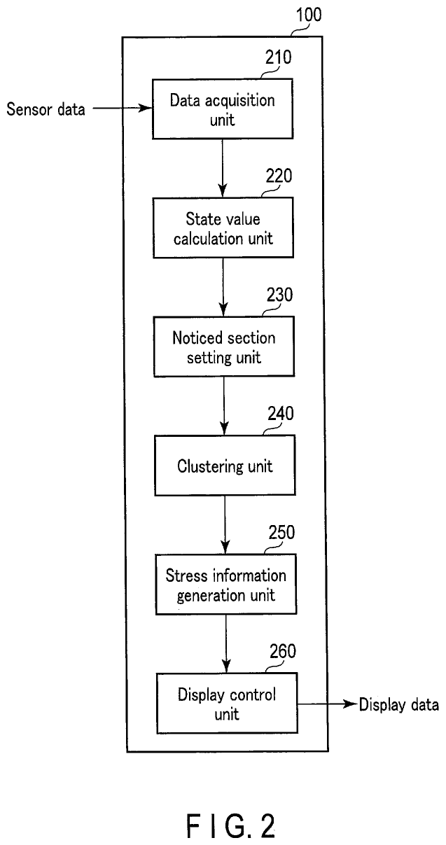

FIG. 2 is a block diagram illustrating a configuration of the analysis apparatus according to the first embodiment. The analysis apparatus 100 in FIG. 2 includes a data acquisition unit 210, a state value calculation unit 220, a noticed section setting unit 230, a clustering unit 240, a stress information generation unit 250, and a display control unit 260.

The data acquisition unit 210 acquires the sensor data from each of the first sensor 121, the second sensor 122, and the third sensor 123. Hereinafter, in a case where there is no need to distinguish these three pieces of sensor data, the three pieces of sensor data are simply referred to as sensor data. The data acquisition unit 210 outputs the acquired sensor data to the state value calculation unit 220. The sensor data includes data in which, for example, time and the measurement data of each of the sensors are associated with each other. It is to be noted that the data acquisition unit 210 may cause a storage unit (not shown in FIG. 2) which the analysis apparatus 100 includes to store the acquired sensor data or may transmit the acquired sensor data to an external storage device, a server, and the like.

The state value calculation unit 220 receives the sensor data from the data acquisition unit 210. The state value calculation unit 220 calculates a state value based on the sensor data. The state value calculation unit 220 outputs time-series data of the calculated state value to the noticed section setting unit 230. It is to be noted that the state value calculation unit 220 may cause the storage unit which the analysis apparatus 100 includes to store the time-series data of the calculated state value or may transmit the time-series data of the calculated state value to the external storage device, the server, and the like.

The state value includes, for example, at least body stress value. As the body stress value, there is, for example, a posture stress value which represents a degree of a load in a work posture, which possibly causes stress (a load) regarding each of the body sites, by a numerical value. For example, based on the sensor data, an angle from a reference position at a site corresponding to the sensor attached to the measurement target and a duration are estimated, and based on the estimated angle and duration, the posture stress value is calculated. The posture stress value represents that the larger the posture stress value is, the larger the stress is. It is to be noted that the posture stress value may be referred to as a load value.

In addition, the state value may include a psychological stress value. As the psychological stress value, there is, for example, an LF/HF value which represents a frequency component of heart rate variability by a ratio. The LF/HF value is calculated by performing frequency analysis of variability of a RR interval of a heart rate, as a ratio of power values of a low frequency region (LF) and a high frequency region (HF) of a spectrum. The LF/HF value represents, for example, a parasympathetic nerve predominant state in accordance with a decrease in the LF/HF value, that is, a relaxing state and a sympathetic nerve predominant state in accordance with an increase in the LF/HF value, that is, a stress-felt state.

Furthermore, the state value may include a degree of happiness. A communication quantity is measured based on voice data of the measurement target, and based on the measured communication quantity, the degree of happiness is estimated.

It is to be noted that in the subsequent specific example, it is descried that the state value is the posture stress value. Therefore, the time-series data of the state value is data, for example, in which the time and the posture stress value (load value) regarding a site corresponding to each of the sensors are associated with each other.

The noticed section setting unit 230 receives the time-series data of the state value from the state value calculation unit 220. The noticed section setting unit 230 sets a plurality of noticed sections based on the time-series data of the state value and predetermined criteria. The noticed section setting unit 230 outputs information (noticed section information) of the state value regarding the set plurality of noticed sections to the clustering unit 240.

The predetermined criteria are, for example, a predetermined time length and a predetermined threshold value regarding the state value. Therefore, the noticed section setting unit 230 extracts sections in the time-series data of the state value, in each of which the state value exceeds the predetermined threshold value over a predetermined time length or more and sets the sections as the noticed sections.

It is to be noted that hereinafter, time-series data included in each of the noticed sections is referred to as a time-series pattern. In addition, in a case where a plurality of time-series patterns is included in the noticed sections, the plurality of time-series patterns is referred to as a time-series pattern set.

The clustering unit 240 receives the noticed section information from the noticed section setting unit 230. The clustering unit 240 performs clustering by using state values regarding the plurality of noticed sections included in the noticed section information and generates a clustering result. The clustering unit 240 outputs the clustering result to the stress information generation unit 250.

Specifically, by merging time-series patterns (a time-series pattern set) regarding each of a plurality of elements included in the sensor data as to each of the plurality of noticed sections, the clustering unit 240 generates a merged time-series pattern. The plurality of elements shows each of the sites corresponding to each of the sensors. For example, in a case where sensors are respectively attached to an upper arm of the measurement target, a wrist thereof, and a waist thereof, by merging a time-series pattern regarding the upper arm, a time-series pattern regarding the wrist, and a time-series pattern regarding the waist, the clustering unit 240 generates a merged time-series pattern.

There are, for example, the following two methods for generating the merged time-series pattern. A first method is a method in which by combining time-series patterns (time-series pattern sets) regarding the plurality of elements in a time direction, the clustering unit 240 generates the merged time-series pattern. A second method is a method in which by overlaying the time-series patterns (the time-series pattern sets) regarding the plurality of elements, the clustering unit 240 generates the merged time-series pattern. It is to be noted that the merged time-series pattern generated by the first method may be referred to as a combined time-series pattern. In addition, although the order in which the time-series patterns are combined is any order, the order is unified among the plurality of time-series pattern sets.

Next, the clustering unit 240 calculates a degree of similarity among the generated plurality of merged time-series patterns. The degree of similarity is, for example, a distance between two time-series patterns, obtained by employing a dynamic time warping (DTW) method. The DTW method allows a difference in shapes of the time-series patterns to be evaluated while considering expansion and contraction in a time direction. Therefore, by employing the DTW method, the clustering unit 240 can appropriately calculate the degree of similarity even when time lengths of the two time-series patterns are different from each other.

It is to be noted that when calculating the degree of similarity, by elongating and contracting the time lengths of the time-series patterns, the clustering unit 240 may make the time lengths of the two time-series patterns even. In a case where the time lengths of the two time-series patterns are made even, the distance therebetween is not limited to the distance obtained by employing the DTW method, the clustering unit 240 may calculate a Euclidean distance or the like as the degree of similarity.

Furthermore, based on the calculated plurality of degrees of similarity, the clustering unit 240 performs clustering in which noticed sections whose degrees of similarity are close to each other are clustered as the same cluster and generates a clustering result. As a clustering method, for example, a K-Means method (K-Means clustering) is employed. In addition, as the clustering method, any method such as hierarchical clustering and density-based spatial clustering of application with noise (DBSCAN) may be employed.

The clustering result includes data, for example, in which pieces of information of characteristic samples corresponding to the noticed sections represented in positions of any coordinate axes (for example, sample IDs) and pieces of information to distinguish clusters (for example, cluster IDs) are associated with each other.

It is to be noted that the clustering unit 240 is not necessarily required to generate the merged time-series pattern. In a case where the merged time-series pattern is not generated, the clustering unit 240 calculates degrees of similarity as to the plurality of time-series patterns regarding the plurality of elements in the noticed sections and based on a sum of the plurality of degrees of similarity regarding the plurality of elements, performs clustering. It is only required to employ a method similar to each of the above-described methods for the calculation of the degrees of similarity and the clustering.

The stress information generation unit 250 receives the clustering result from the clustering unit 240. Based on the clustering result, the stress information generation unit 250 generates stress information which includes pieces of characteristic information of the plurality of clusters. The stress information generation unit 250 outputs the generated stress information to the display control unit 260.

The characteristic information is, for example, a time-series pattern set (representative time-series pattern set) which is representative of each of the clusters. The representative time-series pattern set may be an average time-series pattern set in which a plurality of time-series pattern sets included in each of the clusters is averaged for each of the elements or may be a time-series pattern set of a noticed section whose degree of similarity with the average time-series pattern set is maximum. It is to be noted that it is only required for at least either of the clustering unit 240 and the stress information generation unit 250 to calculate the average time-series pattern set.

Furthermore, the stress information may include information relevant to the characteristic information (relevant information). The relevant information includes, for example, a graph which shows a work image corresponding to the time-series pattern set of the noticed section whose degree of similarity with the average time-series pattern set is maximum and the clustering result. In addition, the relevant information may include a graph which shows the time-series data of the state values.

The display control unit 260 receives the stress information from the stress information generation unit 250. The display control unit 260 generates display data based on the stress information and causes a display, which is the output apparatus 110, to display the display data.

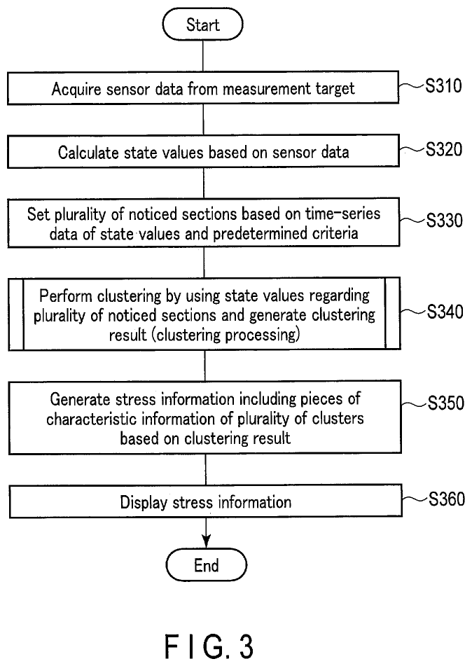

Hereinbefore, the configurations of the analysis system 1 and the analysis apparatus 100 according to the first embodiment are described. Next, with reference to a flowchart in FIG. 3, operation of the analysis apparatus 100 will be described.

FIG. 3 is the flowchart illustrating the operation of the analysis apparatus according to the first embodiment. An analysis program is executed by a user, thereby starting processing illustrated in the flowchart in FIG. 3.

### (Step S310)

When the analysis program is executed, the data acquisition unit 210 acquires the sensor data from the measurement target.

### (Step S320)

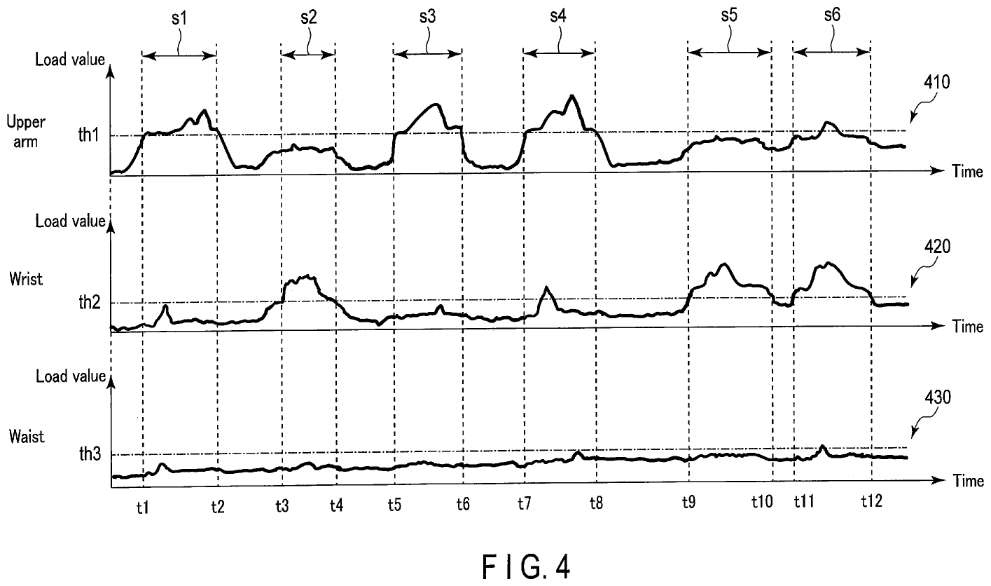

After the sensor data has been acquired, based on the sensor data, the state value calculation unit 220 calculates state values. Hereinafter, as an example of the time-series data of the calculated state values, with reference to FIG. 4, description will be given.

FIG. 4 is a graph showing load values of an upper arm, a wrist, and a waist of a worker in the first embodiment in a time-series manner. In FIG. 4, a graph 410 regarding the load values of the upper arm, a graph 420 regarding the load values of the wrist, and a graph 430 regarding the load values of the waist are shown in common time axes. These graph 410, graph 420, and graph 430 correspond to pieces of time-series data of the state values.

### (Step S330)

After the state values have been calculated, based on the pieces of time-series data of the state values and the predetermined criteria, the noticed section setting unit 230 sets the plurality of noticed sections. Hereinafter, as a specific example of setting of the plurality of noticed sections, description will be given again with reference to FIG. 4.

First, the graph 410 will be described. The noticed section setting unit 230 sets a threshold value th1 regarding the load values of the upper arm and extracts, as the noticed sections, sections in which load values exceed the threshold value th1 over the predetermined time length or more in the graph 410. In FIG. 4, as the extracted noticed sections, three noticed sections, which are a noticed section s1 from time t1 to time t2, a noticed section s3 from time t5 to time t6, and a noticed section s4 from time t7 to time t8, are shown.

Next, the graph 420 will be described. The noticed section setting unit 230 sets a threshold value th2 regarding the load values of the wrist and extracts, as the noticed sections, sections in which load values exceed the threshold value th2 over the predetermined time length or more in graph 420. In FIG. 4, as the extracted noticed sections, three noticed sections, which are a noticed section s2 from time t3 to time t4, a noticed section s5 from time t9 to time t10, and a noticed section s6 from time t11 to time t12, are shown.

Finally, the graph 430 will be described. The noticed section setting unit 230 sets a threshold value th3 regarding the load values of the waist and extracts, as the noticed sections, sections in which load values exceed the threshold value th3 over the predetermined time length or more in graph 430. It is to be noted that in FIG. 4, as to the graph 430, no noticed sections are extracted.

Here, as to the above-described terms, confirmation is made again with reference to FIG. 4. For example, the time-series data included in the noticed section s1 in graph 410 is referred to as the time-series pattern. Similarly, each of the time-series data included in the noticed section s1 in graph 420 and the time-series data in graph 430 is also referred to as the time-series pattern. Then, the plurality of time-series patterns is referred to as the time-series pattern set. Therefore, the time-series pattern set of the noticed section s1 includes the time-series pattern regarding the upper arm, the time-series pattern regarding the wrist, and the time-series pattern regarding the waist, which are included in the noticed section s1 from time t1 to time t2. These are applied similarly to the other noticed sections.

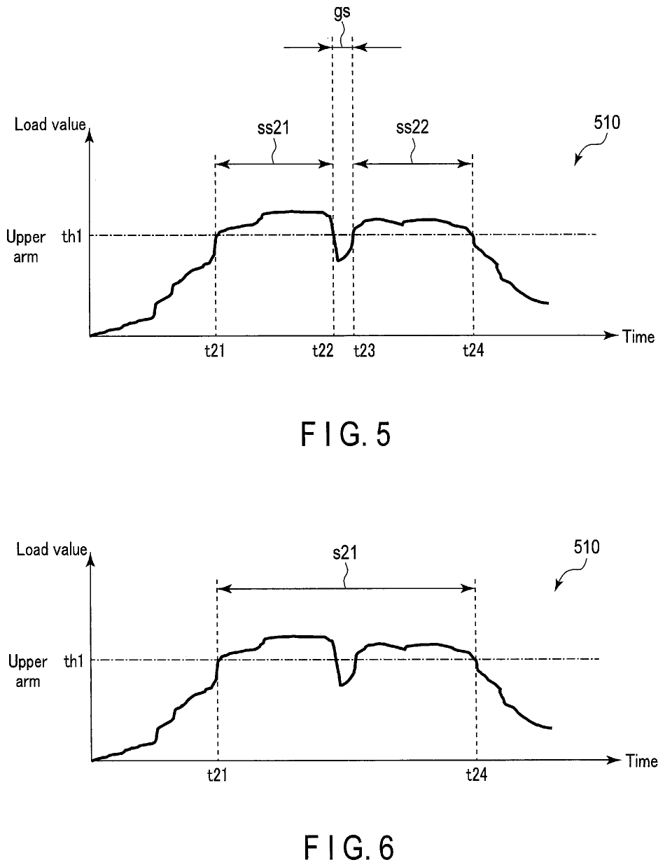

It is to be noted that the noticed section setting unit 230 may alleviate conditions (setting criteria) as to the setting of the noticed sections. For example, in a case where load values in the time-series data fall below the threshold value, when a value of a time length in a section, over which the load values in the time-series data fall below the threshold value is smaller than a predetermined value, the noticed section setting unit 230 may set noticed sections together with noticed sections before and after the above-mentioned section in a case where time lengths of the noticed sections before and after the above-mentioned section exceed the predetermined time length. Hereinafter, with reference to FIGS. 5 and 6, another example of setting criteria of a plurality of noticed sections will be described.

FIG. 5 is a diagram explaining another example of the setting criteria of the noticed sections in the first embodiment. In FIG. 5, a graph 510 regarding load values of the upper arm is shown. The noticed section setting unit 230 sets a threshold value th1 regarding the load values of the upper arm and extracts, as noticed sections, sections in which load values exceed the threshold value th1 over a predetermined time length or more in the graph 510.

For example, in FIG. 5, in the graph 510, load values exceed the threshold value th1 in a small section ss21 from time t21 to time t22, load values temporarily fall below the threshold value th1 in a gap section gs from time t22 to time t23, and load values exceed the threshold value th1 in a small section ss22 from time t23 to time t24. Here, since in each of the small section ss21 and the small section ss22, the load values fall below the predetermined time length in the predetermined criteria, it is defined that the small section ss21 and the small section ss22 do not satisfy the criteria as the noticed sections. In addition, it is defined that load values in the gap section gs are smaller than a predetermined value. At this time, the noticed section setting unit 230 disregards the gap section gs and compares a time length in a section from time t21 to time t24 with a predetermined time length. Thus, a noticed section shown in the next FIG. 6 is set.

FIG. 6 is a diagram explaining the noticed section set in another example in FIG. 5. In FIG. 6, as in FIG. 5, the graph 510 is shown. In FIG. 6, it is defined that a time length of a section from time t21 to time t24, that is, a section in which the small section ss21, the gap section gs, and the small section ss22 are added together exceeds a predetermined time length in the predetermined criteria. Therefore, the noticed section setting unit 230 sets a section from time t21 to time t24 as a noticed section s21.

### (Step S340)

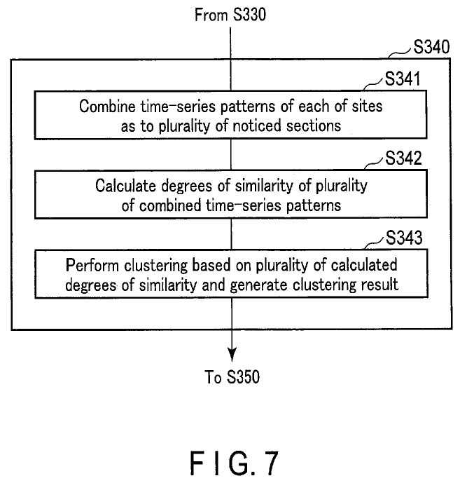

After the plurality of noticed sections has been set, the clustering unit 240 performs clustering by using the state values regarding the plurality of noticed sections and generates the clustering result. Hereinafter, processing in step S340 is referred to as “clustering processing”. With reference to a flowchart in FIG. 7, a specific example of the clustering processing will be described.

FIG. 7 is the flowchart illustrating the clustering processing in the flowchart in FIG. 3. The flowchart in FIG. 7 shifts from step S330 in FIG. 3. It is to be noted that in the flowchart in FIG. 7, an example in which the clustering unit 240 generates the merged time-series patterns (combined time-series patterns) by combining the time-series pattern sets in the time direction.

### (Step S341)

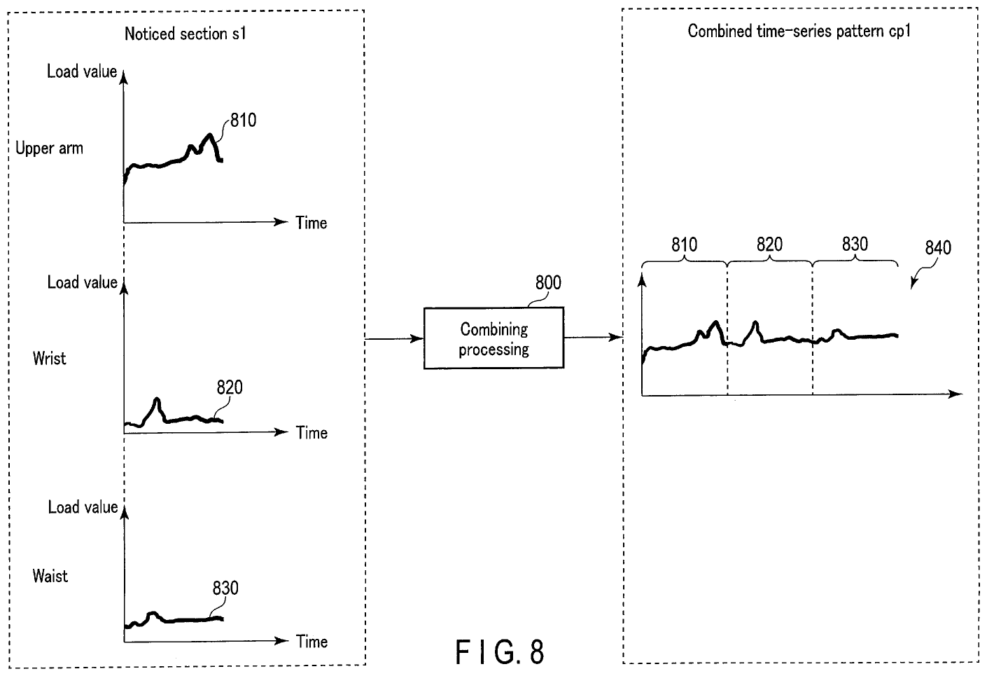

After the plurality of noticed sections has been set, the clustering unit 240 combines the time-series patterns of the sites as to the plurality of noticed sections. Hereinafter, with reference to FIG. 8, processing in which the time-series patterns are combined (combining processing) will be described.

FIG. 8 is a diagram explaining the combining processing in the first embodiment. In FIG. 8, a time-series pattern set of a noticed section s1 is shown. In the time-series pattern set, time-series data 810 of an upper arm, time-series data 820 of a wrist, and time-series data 830 of a waist are included. By subjecting the time-series pattern set of the noticed section s1 to the combining processing 800, the clustering unit 240 generates a combined time-series pattern cp1. The combined time-series pattern cp1 corresponds to a graph 840 in which the time-series data 810, the time-series data 820, and the time-series data 830 are combined in a time direction. It is to be noted that the combining processing 800 is performed similarly for the noticed section s2 to the noticed section s6 which are shown in FIG. 4.

### (Step S342)

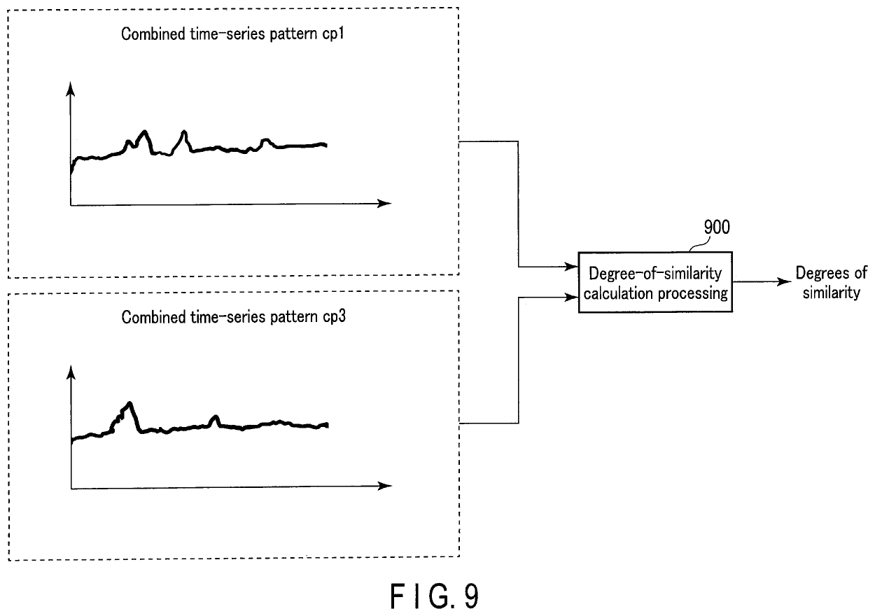

After the time-series patterns have been combined, the clustering unit 240 calculates degrees of similarity of each of a plurality of combined time-series patterns. Hereinafter, with reference to FIG. 9, processing in which degrees of similarity of each of the plurality of time-series pattern are calculated (degree-of-similarity calculation processing) will be described.

FIG. 9 is a diagram explaining the degree-of-similarity calculation processing in the first embodiment. In FIG. 9, a combined time-series pattern cp1 corresponding to a noticed section s1 and a combined time-series pattern cp3 corresponding to a noticed section s3 are shown. By performing the degree-of-similarity calculation processing 900 based on the combined time-series pattern cp1 and the combined time-series pattern cp3, the clustering unit 240 calculates the degrees of similarity. It is to be noted that the degree-of-similarity calculation processing 900 is performed for all of two different combinations among the plurality of combined time-series patterns corresponding to the plurality of noticed sections shown in FIG. 4.

### (Step S343)

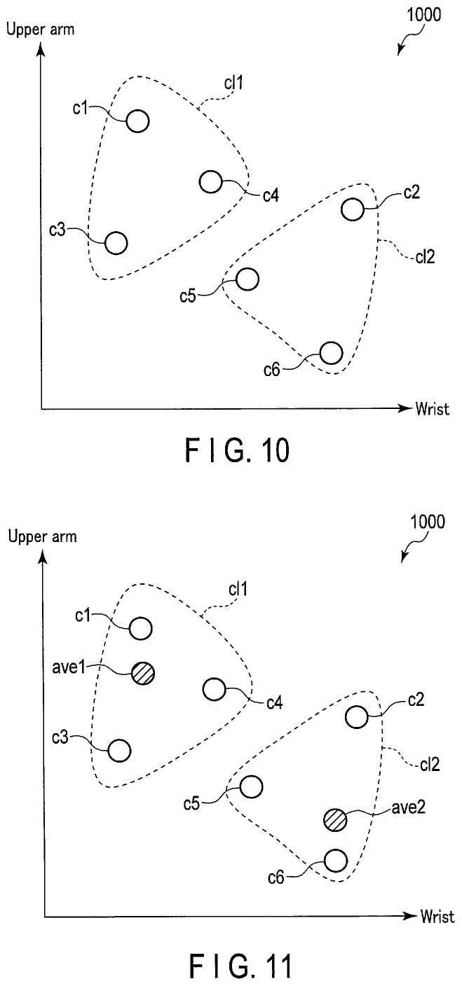

After the degrees of similarity have been calculated, based on the calculated plurality of degrees of similarity, the clustering unit 240 performs clustering and generates a clustering result. After step S343, the processing proceeds to step S350 in FIG. 3. Hereinafter, with reference to FIG. 10, the clustering result will be described.

FIG. 10 is a diagram explaining the clustering result of the plurality of characteristic samples corresponding to the plurality of noticed sections plotted on two-dimensional coordinates in the first embodiment. In FIG. 10, load values of the wrist are arranged in such a way as to correspond to a horizontal axis on the two-dimensional coordinates, and load values of the upper arm are arranged in such a way as to correspond to a vertical axis thereon. In the clustering result 1000 in FIG. 10, as two clusters, a first cluster c11 and a second cluster c12 are shown. In the first cluster c11, a characteristic sample c1 corresponding to the noticed section s1, a characteristic sample c3 corresponding to the noticed section s3, and a characteristic sample c4 corresponding to the noticed section s4 are included. In the second cluster c12, a characteristic sample c2 corresponding to the noticed section s2, a characteristic sample c5 corresponding to the noticed section s5, and a characteristic sample c6 corresponding to the noticed section s6 are included.

### (Step S350)

After the clustering result has been generated, based on the clustering result, the stress information generation unit 250 generates pieces of stress information which include pieces of characteristic information of the plurality of clusters. Hereinafter, an example in which the characteristic information is a time-series pattern set of noticed sections whose degree of similarity with an average time-series pattern set is maximum will be described. The average time-series pattern set corresponds to an average characteristic sample which is an average of characteristic samples in each of the clusters. With reference to FIG. 11, the average characteristic sample will be described.

FIG. 11 is a diagram explaining the average characteristic sample in each of the clusters in FIG. 10. In FIG. 11, a first average characteristic sample ave1 which is an average of the characteristic samples included in the first cluster c11 and a second average characteristic sample ave2 which is an average of characteristic samples included in the second cluster c12 are shown. The stress information generation unit 250 aggregates the characteristic samples included in the clusters as to each of the clusters and averages the characteristic samples, thereby determining the above-mentioned two average characteristic samples.

Furthermore, the stress information generation unit 250 determines a characteristic sample close to the average characteristic sample for each of the clusters. Hereinafter, it is defined that the stress information generation unit 250 determines a characteristic sample c1 close to the first average characteristic sample ave1 as to the first cluster c11 and determines a characteristic sample c6 close to the second average characteristic sample ave2 as to the second cluster c12. Therefore, the stress information generation unit 250 generates the time-series pattern set of the noticed section s1 corresponding to the characteristic sample c1 and the time-series pattern set of the noticed section s6 corresponding to the characteristic sample c6 as the pieces of characteristic information. At this time, the pieces of characteristic information (time-series pattern sets) are extracted from, for example, the time-series data of state values shown in FIG. 4 and are thereby generated.

Then, the stress information generation unit 250 generates pieces of stress information which include the generated characteristic information and relevant information regarding the characteristic information.

### (Step S360)

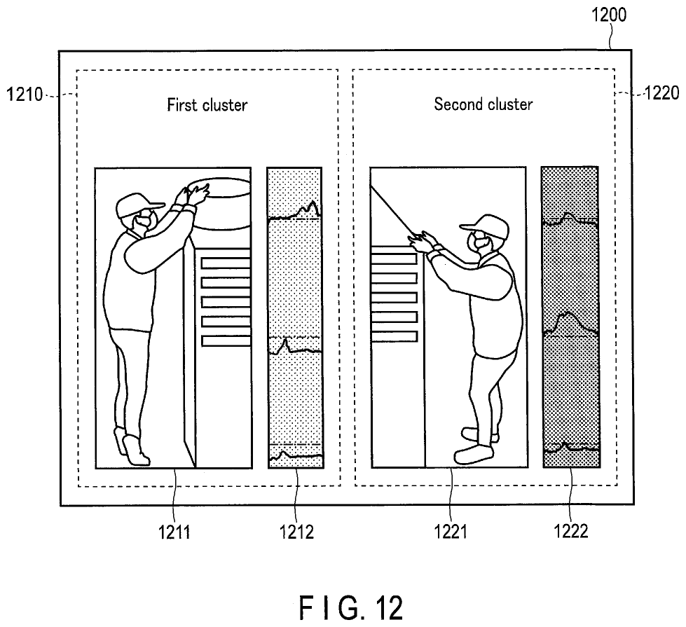

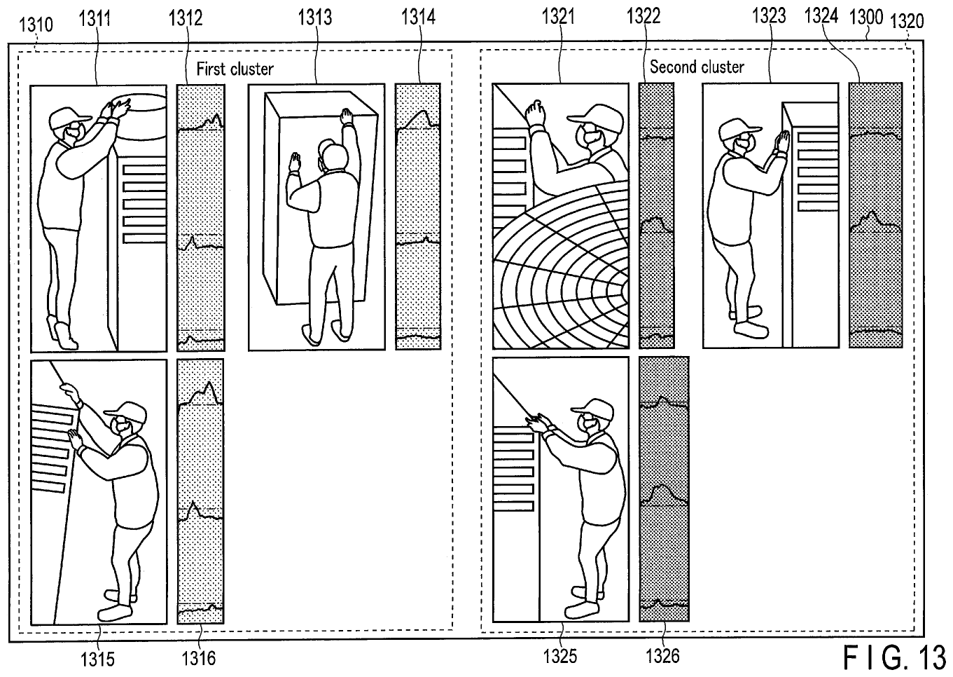

After the stress information has been generated, the display control unit 260 causes the display to display the stress information. Specifically, the display control unit 260 causes the display, which is the output apparatus 110, to display the display data based on the stress information. After step S360, the analysis program is finished. Hereinafter, with reference to FIGS. 12 and 13, an example of the display data in a case where as the relevant information, work images are included will be described.

FIG. 12 is a diagram illustrating the display data based on the stress information in the first embodiment. The display data 1200 in FIG. 12 has a display region 1210 where information regarding a first cluster is displayed and a display region 1220 where information regarding a second cluster is displayed.

In the display region 1210, a work image 1211 which is representative of the first cluster and a time-series pattern set 1212 are displayed. The work image 1211 is an image corresponding to the time-series pattern set 1212. The time-series pattern set 1212 is a time-series pattern set of the noticed section s1 corresponding to the characteristic sample c1 in FIGS. 10 and 11.

In the display region 1220, a work image 1221 which is representative of the second cluster and a time-series pattern set 1222 are displayed. The work image 1221 is an image corresponding to the time-series pattern set 1222. The time-series pattern set 1222 is a time-series pattern set of the noticed section s6 corresponding to the characteristic sample c6 in FIGS. 10 and 11.

Therefore, since in the display data 1200, grouping is made in accordance with differences in loads in the same work, a user visually recognizes the display data 1200, thereby allowing the user to confirm the differences in the loads in the same work. For example, in the time-series pattern set 1212, a load value of the time-series pattern of the upper arm exceeds the threshold value, and in the work image 1211, a view in which a load is exerted on the upper arm is shown. On the other hand, in the time-series pattern set 1222, a load value of the time-series pattern of the wrist exceeds the threshold value, and in the work image 1221, a view in which a load is exerted on the wrist is shown.

FIG. 13 is a diagram illustrating other display data based on the stress information in the first embodiment. The display data 1300 in FIG. 13 has a display region 1310 where information regarding a first cluster is displayed and a display region 1320 where information regarding a second cluster is displayed. The display data 1300 is different from the display data 1200 in FIG. 12 in that all work images and time-series pattern sets of each of the clusters are displayed.

In the display region 1310, work images 1311, 1313, and 1315 and time-series pattern sets 1312, 1314, and 1316 in the first cluster are displayed. The work images 1311, 1313, and 1315 are images corresponding to the time-series pattern sets 1312, 1314, and 1316.

The time-series pattern set 1312 is a time-series pattern set of the noticed section s1 corresponding to the characteristic sample c1 in FIGS. 10 and 11. In addition, the time-series pattern set 1314 is a time-series pattern set of the noticed section s3 corresponding to the characteristic sample c3 in FIGS. 10 and 11. In addition, the time-series pattern set 1316 is a time-series pattern set of the noticed section s4 corresponding to the characteristic sample c4 in FIGS. 10 and 11.

In the display region 1320, work images 1321, 1323, and 1325 and time-series pattern sets 1322, 1324, and 1326 in the second cluster are displayed. The work images 1321, 1323, and 1325 are images corresponding to the time-series pattern sets 1322, 1324, and 1326.

The time-series pattern set 1322 is a time-series pattern set of the noticed section s2 corresponding to the characteristic sample c2 in FIGS. 10 and 11. In addition, the time-series pattern set 1324 is a time-series pattern set of the noticed section s5 corresponding to the characteristic sample c5 in FIGS. 10 and 11. In addition, the time-series pattern set 1326 is a time-series pattern set of the noticed section s6 corresponding to the characteristic sample c6 in FIGS. 10 and 11.

Therefore, since in the display data 1300, all pieces of data belonging to all of the clusters are displayed in a listed manner, the user visually recognizes the display data 1300, thereby allowing the user to confirm differences in loads in the same work from a bird's-eye viewpoint. In addition, when focusing attention on the clusters, the user can confirm work classified as the same kind of a load in a listed manner. Thus, for example, even in a case where there is discrepancy between seeming operation and an actual load (for example, in a case where whereas in the work image, a load seems to be exerted on the upper arm, the load is actually exerted on the wrist), the user can correctly analyze causes of loads.

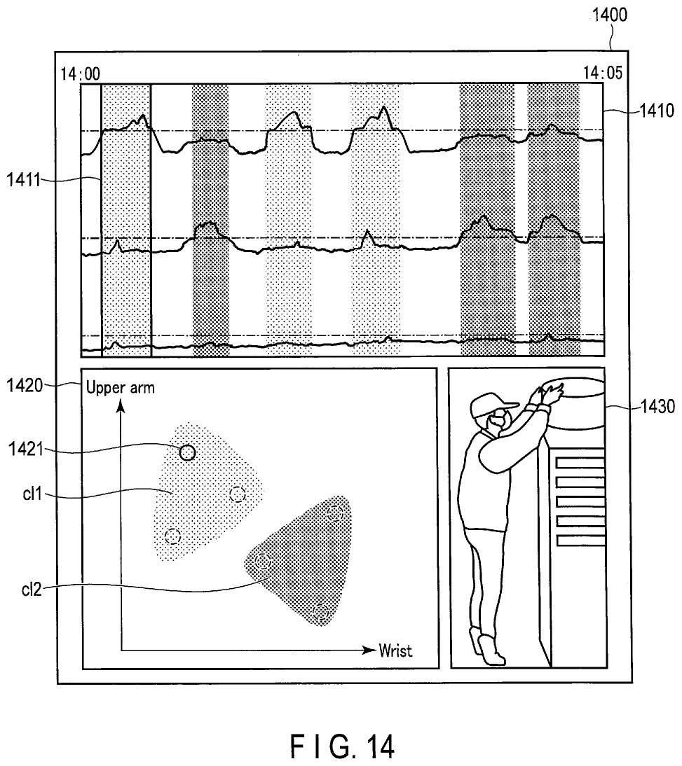

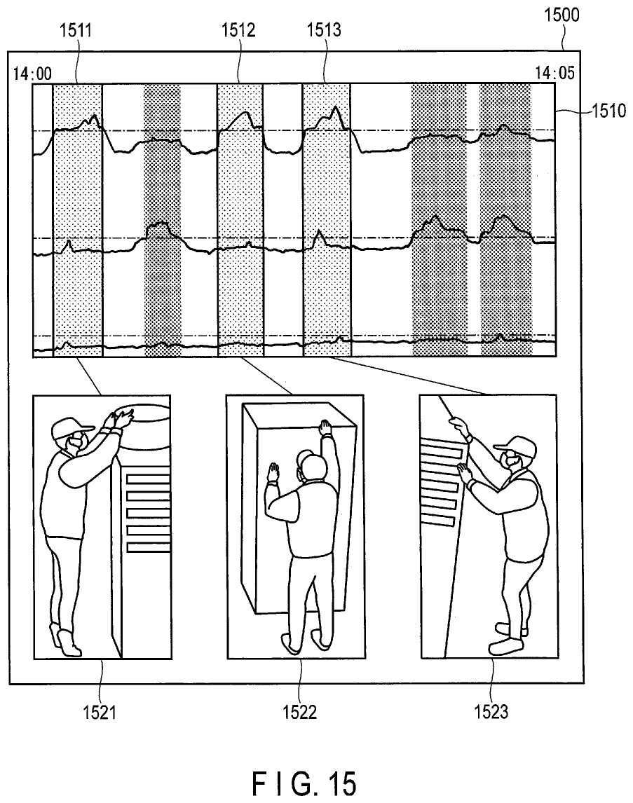

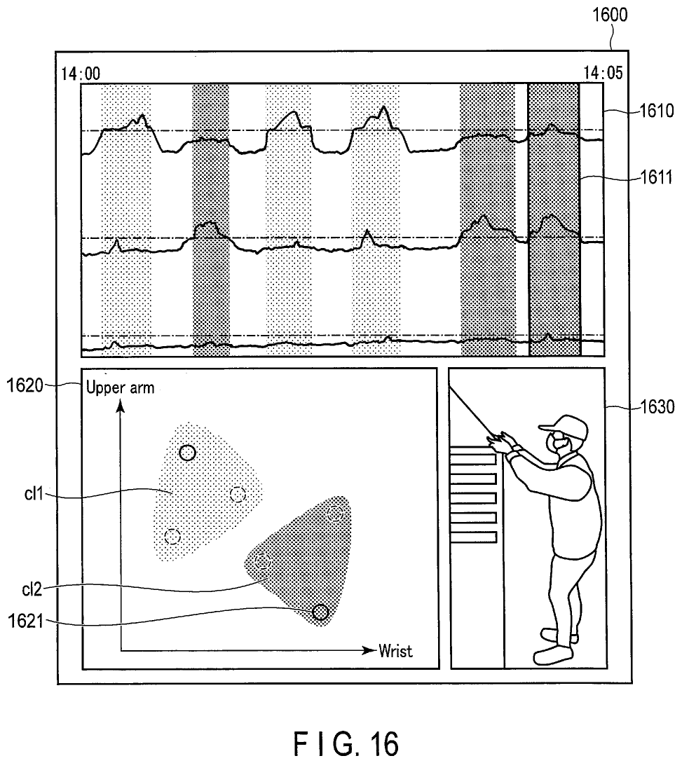

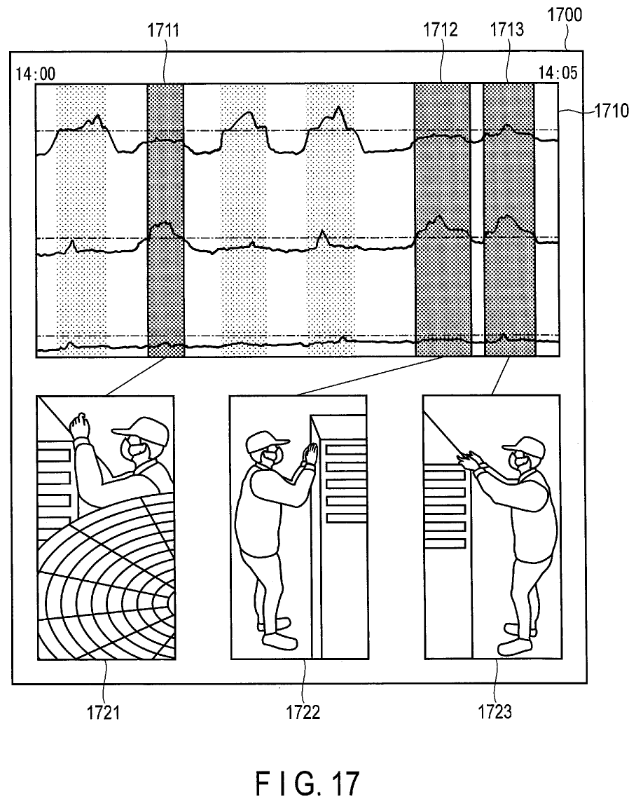

It is to be noted that although in the display data 1200 and the display data 1300, the pieces of information regarding the two clusters are displayed, the present invention is not limited to this. For example, in a case where in the clustering result, three or more clusters are included, pieces of information regarding the three or more clusters may be displayed in the display data. In addition, for example, also in the display data, information regarding a specific cluster among a plurality of clusters may be selected and displayed. Hereinafter, as to the clustering result in FIG. 10, with reference to FIGS. 14 and 15, an example in which the information regarding the first cluster is displayed will be described, and with reference to FIGS. 16 and 17, an example in which the information regarding the second cluster is displayed will be described.

FIG. 14 is a diagram illustrating the display data regarding the first cluster in the first embodiment. The display data 1400 in FIG. 14 includes a graph 1410 as to time-series data of state values, a clustering result 1420, and a work image 1430.

The graph 1410 includes the graph 410, the graph 420, and the graph 430 in FIG. 4. In addition, as to six noticed sections in the graph 1410, color-coding is made so as to allow the first cluster and the second cluster to be distinguished. This color-coding corresponds to color-coding of clustering in the later-described clustering result 1420. In addition, in the graph 1410, a time-series pattern set 1411 corresponding to the noticed section s1 which is representative of the first cluster is displayed in a highlighted manner. The clustering result 1420 is substantially similar to the clustering result 1000 of FIG. 10. In the clustering result 1420, color-coding, whose ways are different from each other, is made in ranges of the first cluster c11 and the second cluster c12. In addition, in the clustering result 1420, a characteristic sample 1421 corresponding to the noticed section s1 which is representative of the first cluster is displayed in a highlighted manner.

The work image 1430 is the same as the work image 1211 in FIG. 12. The work image 1430 corresponds to the time-series pattern set 1411 in the graph 1410 and the characteristic sample 1421 in the clustering result 1420.

Therefore, since in the display data 1400, the time-series pattern set 1411, which is representative of the first cluster, and the clustering result 1420, and the work image 1430 can be associated with one another to be displayed, the user visually recognizes the display data 1400, thereby allowing the user to immediately confirm an outline of the first cluster. It is to be noted that similar display can be performed for other time-series pattern sets included in the first cluster.

FIG. 15 is a diagram illustrating other display data regarding the first cluster in the first embodiment. The display data 1500 in FIG. 15 includes a graph 1510 as to time-series data of state values and a plurality of work images 1521, 1522, and 1523.

The graph 1510 is substantially similar to the graph 1410. As a point different from the graph 1410, in the graph 1510, a plurality of time-series pattern sets 1511, 1512, and 1513 respectively corresponding to a plurality of noticed sections s1, s3, and s4 belonging to the first cluster are displayed in a highlighted manner.

The work image 1521 is the same as the work image 1311 in FIG. 13. The work image 1521 corresponds to the time-series pattern set 1511 in the graph 1510. A combination of the work image 1521 and the time-series pattern set 1511 is the same as a combination of the work image 1311 and the time-series pattern set 1312 in FIG. 13.

The work image 1522 is the same as the work image 1313 in FIG. 13. The work image 1522 corresponds to the time-series pattern set 1512 in the graph 1510. A combination of the work image 1522 and the time-series pattern set 1512 is the same as a combination of the work image 1313 and the time-series pattern set 1314 in FIG. 13.

The work image 1523 is the same as the work image 1315 in FIG. 13. The work image 1523 corresponds to the time-series pattern set 1513 in the graph 1510. A combination of the work image 1523 and the time-series pattern set 1513 is the same as a combination of the work image 1315 and the time-series pattern set 1316 in FIG. 13.

Therefore, since in the display data 1500, the plurality of time-series pattern sets 1511, 1512, and 1513 regarding the first cluster and the plurality of work images 1521, 1522, and 1523 can be associated with one another to be displayed, the user visually recognizes the display data 1500, thereby allowing the user to confirm the pieces of information included in the first cluster in a listed manner.

FIG. 16 is a diagram illustrating display data regarding the second cluster in the first embodiment. The display data 1600 in FIG. 16 includes a graph 1610 as to time-series data of state values, a clustering result 1620, and a work image 1430.

The graph 1610 is substantially similar to the graph 1410. As a point different from the graph 1410, in the graph 1610, a time-series pattern set 1611 corresponding to the noticed section s6 which is representative of the second cluster is displayed in a highlighted manner.

The clustering result 1620 is substantially similar to the clustering result 1420. As a point different from the clustering result 1420, in the clustering result 1620, a characteristic sample 1621 corresponding to the noticed section s6 which is representative of the second cluster is displayed in a highlighted manner.

The work image 1630 is the same as the work image 1221 in FIG. 12. The work image 1221 corresponds to the time-series pattern set 1611 in the graph 1610 and a characteristic sample 1621 in the clustering result 1620.

Therefore, since in the display data 1600, the time-series pattern set 1611 which is representative of the second cluster, the clustering result 1620, and the work image 1630 are associated with one another to be displayed, the user visually recognizes the display data 1600, thereby allowing the user to immediately confirm an outline of the second cluster. It is to be noted that similar display can be performed for other time-series pattern sets included in the second cluster.

FIG. 17 is a diagram illustrating other display data regarding the second cluster in the first embodiment. The display data 1700 in FIG. 17 includes a graph 1710 as to time-series data of state values and a plurality of work images 1721, 1722, and 1723.

The graph 1710 is substantially similar to the graph 1410. As a point different from the graph 1410, in the graph 1710, a plurality of time-series pattern sets 1711, 1712, and 1713 respectively corresponding to a plurality of noticed sections s2, s5, ad s6 belonging to the second cluster are displayed in a highlighted manner.

The work image 1721 is the same as the work image 1321 in FIG. 13. The work image 1721 corresponds to a time-series pattern set 1711 in the graph 1710. A combination of the work image 1721 and the time-series pattern set 1711 is the same as a combination of the work image 1321 and the time-series pattern set 1322 in FIG. 13.

The work image 1722 is the same as the work image 1323 in FIG. 13. The work image 1722 corresponds to the time-series pattern set 1712 in the graph 1710. A combination of the work image 1722 and the time-series pattern set 1712 is the same as a combination of the work image 1323 and the time-series pattern set 1324 in FIG. 13.

The work image 1723 is the same as the work image 1325 in FIG. 13. The work image 1723 corresponds to the time-series pattern set 1713 in the graph 1710. A combination of the work image 1723 and the time-series pattern set 1713 is the same as a combination of the work image 1325 and the time-series pattern set 1326 in FIG. 13.

Therefore, since in the display data 1700, the plurality of time-series pattern sets 1711, 1712, and 1713 and the plurality of work images 1721, 1722, and 1723 regarding the second cluster can be associated with one another to be displayed, the user visually recognizes the display data 1700, thereby allowing the user to confirm the pieces of information included in the second cluster in a listed manner.

In summing up the description given above, the user visually recognizes each of the display data 1400, the display data 1500, the display data 1600, and the display data 1700, thereby allowing the user to visually confirm contents of the work as to each of the clusters and to easily perform factor analysis of the loads.

As described above, the analysis apparatus according to the first embodiment acquires the sensor data from the measurement target; based on the sensor data, calculates the state values; based on the time-series data of the state values and the predetermined criteria, sets the plurality of noticed sections in the time-series data; performs the clustering by using the state values regarding the plurality of noticed sections; generates the clustering result; and based on the clustering result, generates the pieces of stress information including the pieces of characteristic information of the plurality of respective clusters.

Accordingly, since the analysis apparatus according to the first embodiment performs the clustering by using the plurality of noticed sections and can thereby classify the states of the measurement target, thus enabling adequate analysis of causes of the loads.

### Modification of First Embodiment

In the first embodiment, it is described that when the noticed sections are set, one threshold value and the load values are compared. On the other hand, in a modification of the first embodiment, it will be described that when the noticed sections are set, a plurality of threshold values and the load values are compared.

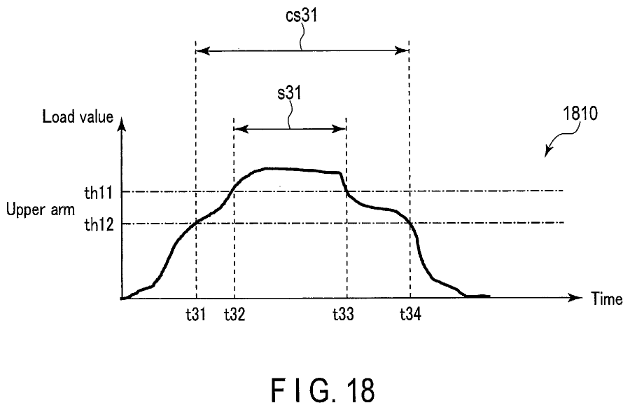

FIG. 18 is a diagram explaining a setting criterion of a candidate noticed section in the modification of the first embodiment. In FIG. 18, a graph 1810 regarding load values of the upper arm is shown. The noticed section setting unit 230 sets a first threshold value th1l regarding the load values of the upper arm and a second threshold value th12 which is equal to or less than the first threshold value th11. After the two threshold values have been set, the noticed section setting unit 230 extracts, as a noticed section, a section in which the load values exceed the first threshold value th11 over a predetermined time length or more in the graph 1810 and extracts, as a candidate noticed section, a section in which the load values exceed the second threshold value th12 therein.

For example, in FIG. 18, in the graph 1810, the load values exceed the first threshold value th11 in a section from time t32 to time t33, and the load values exceed the second threshold value th12 in a section from time t31 to time t34. Therefore, the noticed section setting unit 230 sets, as the noticed section s31, the section from time t32 to time t33 and sets, as the candidate noticed section cs31, the section from time t31 to time t34.

In FIG. 18, although the noticed section s31 is embraced in the candidate noticed section cs31, in a case where the load values change to be the second threshold value th12 or more and the first threshold value th11 or less, it is considered that only candidate noticed sections are set. Therefore, in clustering processing in a subsequent stage, candidate noticed sections may be used, instead of the noticed sections.

### SECOND EMBODIMENT

In each of the first embodiment and the modification of the first embodiment, the case where a kind of operation (operation kind) is not considered or the operation kind is already known is described. On the other hand, in a second embodiment, a case where an operation kind of a worker is determined from sensor data will be described.

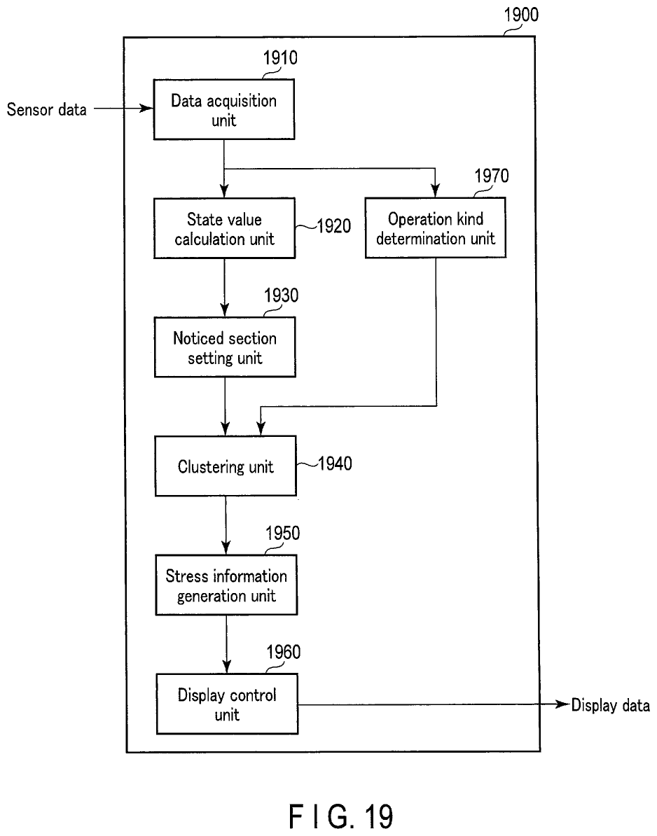

FIG. 19 is a block diagram illustrating a configuration of an analysis apparatus according to the second embodiment. The analysis apparatus 1900 in FIG. 19 includes a data acquisition unit 1910, a state value calculation unit 1920, a noticed section setting unit 1930, a clustering unit 1940, a stress information generation unit 1950, a display control unit 1960, and an operation kind determination unit 1970.

It is to be noted that since the state value calculation unit 1920, the noticed section setting unit 1930, the stress information generation unit 1950, and the display control unit 1960 operate in a manner similar to the manner in which the state value calculation unit 220, the noticed section setting unit 230, the stress information generation unit 250, and the display control unit 260 in FIG. 2 operate, description therefor is omitted.

The data acquisition unit 1910 acquires pieces of sensor data respectively from a first sensor 121, a second sensor 122, and a third sensor 123. The data acquisition unit 1910 outputs the acquired pieces of sensor data to the state value calculation unit 1920 and the operation kind determination unit 1970.

The operation kind determination unit 1970 receives the pieces of sensor data from the data acquisition unit 1910. Based on the pieces of sensor data, the operation kind determination unit 1970 determines operation kinds. The operation kind determination unit 1970 outputs information of the determined operation kinds (operation kind information) to the clustering unit 1940.

The clustering unit 1940 receives noticed section information from the noticed section setting unit 1930 and receives the operation kind information from the operation kind determination unit 1970. The clustering unit 1940 performs clustering by using state values regarding a plurality of noticed sections and the operation kinds and generates a clustering result. The clustering unit 1940 outputs the clustering result to the stress information generation unit 1950.

Specifically, the clustering unit 1940 classifies the plurality of noticed sections for each of the operation kinds. Next, the clustering unit 1940 generates a merged time-series pattern by merging time-series pattern sets as to the plurality of noticed sections of each of the operation kinds. Next, the clustering unit 1940 calculates degrees of similarity among a plurality of merged time-series patterns generated for each of the operation kinds. Finally, based on the calculated plurality of degrees of similarity, the clustering unit 1940 performs clustering for each of the operation kinds and generates a clustering result.

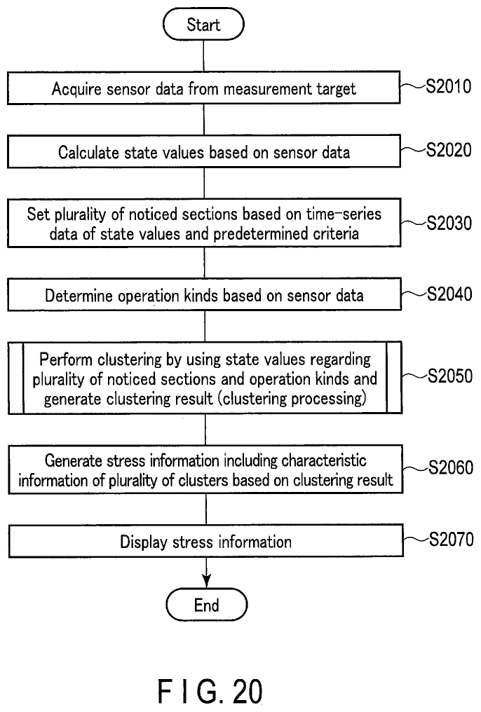

Hereinbefore, the configuration of the analysis apparatus 1900 according to the second embodiment is described. Next, with reference to a flowchart in FIG. 20, operation of the analysis apparatus 1900 will be described.

FIG. 20 is a flowchart illustrating the operation of the analysis apparatus according to the second embodiment. An analysis program is executed by a user, thereby starting processing in the flowchart in FIG. 20.

### (Step S2010)

When the analysis program is executed, the data acquisition unit 1910 acquires sensor data from a measurement target.

### (Step S2020)

After the sensor data has been acquired, based on the sensor data, the state value calculation unit 1920 calculates state values.

### (Step S2030)

After the state values have been calculated, based on time-series data of the state values and predetermined criteria, the noticed section setting unit 1930 sets a plurality of noticed sections.

### (Step S2040)

After the plurality of noticed sections has been set, based on the sensor data, the operation kind determination unit 1970 determines operation kinds.

### (Step S2050)

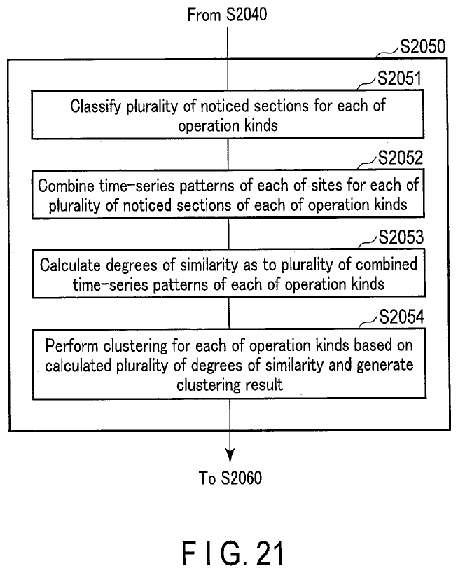

After the operation kinds have been determined, the clustering unit 1940 performs clustering by using the state values regarding the plurality of noticed sections and the operation kinds and generates a clustering result. Hereinafter, processing in step S2050 is referred to as “clustering processing”. With reference to a flowchart in FIG. 21, a specific example of the clustering processing will be described.

FIG. 21 is a flowchart illustrating the clustering processing in the flowchart in FIG. 20. The flowchart in FIG. 21 shifts from step S2040 in FIG. 20.

### (Step S2051)

After the operation kinds have been determined, the clustering unit 1940 classifies a plurality of noticed sections for each of the operation kinds.

### (Step S2052)

After the plurality of noticed sections has been classified for each of a plurality of operation kinds, the clustering unit 1940 combines time-series patterns of each of sites as the plurality of noticed sections of each of the operation kinds.

### (Step S2053)

After the time-series patterns have been combined, the clustering unit 1940 calculates degrees of similarity of each of a plurality of combined time-series patterns of each of the operation kinds.

### (Step S2054)

After the degrees of similarity have been calculated, based on the calculated plurality of degree of similarity, the clustering unit 1940 performs clustering for each of the operation kinds and generates a clustering result. After step S2054, the processing proceeds to step S2060.

### (Step S2060)

After the clustering result has been generated, based on the clustering result, the stress information generation unit 1950 generates stress information including characteristic information of each of a plurality of clusters.

### (Step S2070)

After the stress information has been generated, the display control unit 1960 causes the display to display the stress information. Specifically, the display control unit 1960 causes the display, which is the output apparatus 110, to display the display data based on the stress information. After step S2070, the analysis program is finished.

In the second embodiment, since the clustering processing in consideration of the operation kinds is performed, kinds of display data may be displayed for each of the plurality of operation kinds. In addition, the kinds of information of the display data may be displayed such that the kinds of information of the display data of the plurality of operation kinds can be compared.

As described above, the analysis apparatus according to the second embodiment acquires the sensor data from the measurement target; based on the sensor data, calculates the state values; based on the sensor data, determines the operation kinds of the measurement target; based on the time-series data of the state values and the predetermined criteria, sets the plurality of noticed sections in the time-series data; performs the clustering by using the state values regarding the plurality of noticed sections of each of the operation kinds; generates the clustering result; and based on the clustering result, generates the stress information including the characteristic information of each of the plurality of clusters.

Accordingly, since the analysis apparatus according to the second embodiment can classify states of the measurement target for each of the operation kinds by determining the operation kinds from the work of the measurement target, causes of the loads can be further adequately analyzed.

Accordingly, the analysis apparatus according to the second embodiment performs the clustering by using the plurality of noticed sections and can thereby classify the states of the measurement target in detail, thus enabling adequate analysis of the causes of the loads.

### (Hardware Configuration)

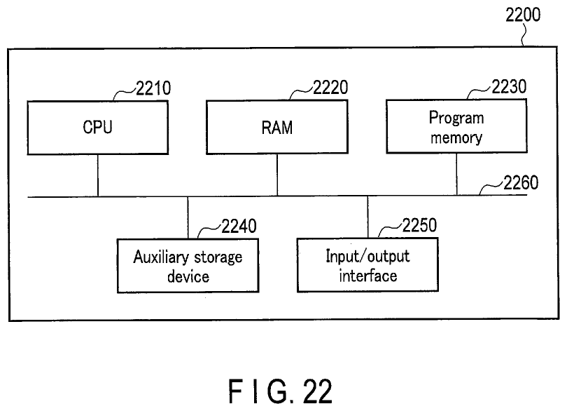

FIG. 22 is a block diagram illustrating a hardware configuration of a computer according to one embodiment. The computer 2200 includes, as pieces of hardware, a central processing unit (CPU) 2210, a random access memory (RAM) 2220, a program memory 2230, an auxiliary storage device 2240, and an input/output interface 2250. The CPU 2210 communicates with the RAM 2220, the program memory 2230, the auxiliary storage device 2240, and the input/output interface 2250 via a bus 2260.

The CPU 2210 is one example of a general-purpose processor. The RAM 2220 is used as a working memory by the CPU 2210. The RAM 2220 includes a volatile memory such as a synchronous dynamic random access memory (SDRAM). The program memory 2230 has stored therein a variety of programs including the analysis program. As the program memory 2230, for example, a read-only memory (ROM), a part of the auxiliary storage device 2240, or a combination thereof is used. The auxiliary storage device 2240 stores data in a non-transitory manner. The auxiliary storage device 2240 includes a non-volatile memory such as an HDD or an SSD.

The input/output interface 2250 is an interface for connecting to or communicating with other devices. The input/output interface 2250 is used to connect to or communicate with, for example, the output apparatus 110, the first sensor 121, the second sensor 122, and the third sensor 123, which are shown in FIG. 1.

Each of the programs stored in the program memory 2230 includes computer-executable instructions. When the programs (computer-executable instructions) are executed by the CPU 2210, the programs cause the CPU 2210 to execute predetermined processing. For example, a load estimating program, when executed by the CPU 2210, causes the CPU 2210 to execute a series of processing described regarding the parts in FIG. 3, FIG. 7, FIG. 20, and FIG. 21.

Each of the programs may be provided for the computer 2200 in a state in which each of the programs is stored in a computer-readable storage medium. In this case, for example, the computer 2200 further includes a drive (not shown) for reading out the data from the storage medium and acquires each of the programs from the storage medium. Examples of the storage medium include a magnetic disk, an optical disk (a CD-ROM, CD-R, DVD-ROM, a DVD-R, or the like), a magneto-optical disk (an MO or the like), and a semiconductor memory. In addition, the programs may be stored on a server on a communication network and the computer 2200 may download each of the programs from the server by using the input/output interface 2250.

Although the general-purpose hardware processor such as the CPU 2210 executes the programs, thereby performing the processing described in the embodiments, the present invention is not limited thereto and the processing may be performed by a dedicated hardware processor such as an application specific integrated circuit (ASIC). The term, processing circuitry (processing unit), implies at least one general-purpose hardware processor, at least one dedicated hardware processor, or a combination of at least one general-purpose hardware processor and at least one dedicated hardware processor. In the example shown in FIG. 22, the CPU 2210, the RAM 2220, and the program memory 2230 correspond to the processing circuitry.

Hence, according to the embodiments described above, the causes of the loads can be adequately analyzed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An analysis apparatus comprising processing circuitry configured to:
acquire sensor data from a measurement target;
calculate a state value based on the sensor data;
set, based on time-series data of the state value and predetermined criteria, a plurality of noticed sections in the time-series data;
perform clustering using the state value regarding each of the noticed sections and generate a clustering result; and
generate, based on the clustering result, stress information including characteristic information of each of a plurality of clusters.

2. The analysis apparatus according to claim 1,
wherein the processing circuitry is further configured to:
generate a merged time-series pattern by merging time-series patterns regarding each of a plurality of elements included in the sensor data as to each of the noticed sections;
calculate degrees of similarity among a generated plurality of merged time-series patterns; and
perform the clustering in which noticed sections whose degrees of similarity are close to each other are clustered as a same cluster based on the calculated plurality of degrees of similarity and generate the clustering result.

3. The analysis apparatus according to claim 1,
wherein the processing circuitry is further configured to:
determine operation kinds of the measurement target based on the sensor data; and
perform the clustering by using the state value regarding each of the noticed sections and the operation kinds and generate the clustering result.

4. The analysis apparatus according to claim 3, wherein the processing circuitry is further configured to:
classify the noticed sections for each of the operation kinds;
generate merged time-series patterns by merging time-series patterns regarding each of a plurality of elements included in the sensor data as to each of the noticed sections of each of the operation kinds;
calculate degrees of similarity among the generated plurality of merged time-series patterns for each of the operation kinds; and
perform the clustering, for each of the operation kinds, in which noticed sections whose degrees of similarity are close to each other are clustered as a same cluster based on the calculated plurality of degrees of similarity and generate the clustering result.

5. The analysis apparatus according to claim 2, wherein the processing circuitry is further configured to generate the merged time-series patterns by combining time-series patterns regarding each of the elements in a time direction.

6. The analysis apparatus according to claim 2, wherein the processing circuitry is further configured to generate the merged time-series patterns by overlaying time-series patterns regarding each of the elements.

7. The analysis apparatus according to claim 2, wherein the processing circuitry is further configured to calculate the degrees of similarity by employing a dynamic time warping (DTW) method.

8. The analysis apparatus according to claim 1, wherein the predetermined criteria includes a predetermined time length and a first threshold value regarding the state value, and the processing circuitry is further configured to extract sections whose each state value exceeds the first threshold value over the predetermined time length in the time-series data and set the extracted plurality of sections as the noticed sections.

9. The analysis apparatus according to claim 8, wherein the predetermined criteria includes a second threshold value smaller than the first threshold value, and the processing circuitry is further configured to:
extract sections whose each state value exceeds the second threshold value over the predetermined time length in the time-series data and set the extracted sections as a plurality of candidate noticed sections; and
perform clustering by using a state value regarding each of the candidate noticed sections and generate another clustering result.

10. The analysis apparatus according to claim 1, wherein the state value includes a load value which represents a degree of a load in a work posture by a numerical value, the work posture possibly causing a load regarding a body site of the measurement target.

11. The analysis apparatus according to claim 1, wherein the state value includes an LF/HF value which represents a frequency component of heart rate variability by a ratio.

12. The analysis apparatus according to claim 1, wherein the processing circuitry is further configured to display display data based on the stress information.

13. The analysis apparatus according to claim 12, wherein the display data includes one or more images regarding each of the plurality of clusters and data of one or more noticed sections extracted from the time-series data corresponding to the one or more images.

14. The analysis apparatus according to claim 13, wherein the display data includes a representative image which is representative of each of the clusters and data of a representative noticed section extracted from the time-series data corresponding to the representative image.

15. The analysis apparatus according to claim 12, wherein the display data includes a plurality of images regarding at least one cluster of the plurality of the clusters.

16. An analysis method comprising:
acquiring sensor data from a measurement target;
calculating a state value based on the sensor data;
setting, based on time-series data of the state value and predetermined criteria, a plurality of noticed sections in the time-series data;
performing clustering by using the state value regarding each of the noticed sections and generate a clustering result; and
generating, based on the clustering result, stress information including characteristic information of each of a plurality of clusters.

17. A non-transitory computer-readable storage medium storing a program for causing a computer to execute processing comprising:
acquiring sensor data from a measurement target;
calculating a state value based on the sensor data;
setting, based on time-series data of the state value and predetermined criteria, a plurality of noticed sections in the time-series data;
performing clustering by using the state value regarding each of the noticed sections and generate a clustering result; and
generating, based on the clustering result, stress information including characteristic information of each of a plurality of clusters.
